(19) United States
(12) Patent Application Publication
(10) Pub. No.: US 2018/0368049 A1
(43) Pub. Date: Dec. 20, 2018

(54) METHOD AND APPARATUS FOR GATHERING NETWORK NEIGHBORHOOD INFORMATION AND GENERATING A REDUCED NEIGHBOR REPORT

(71) Applicant: QUALCOMM Incorporated, San Diego, CA (US)

(72) Inventors: Abhishek Pramod Patil, San Diego, CA (US); George Cherian, San Diego, CA (US); Santosh Abraham, San Diego, CA (US)

(21) Appl. No.: 15/628,604

(22) Filed: Jun. 20, 2017

(51) Int. Cl. H04W 40/24; H04W 8/00

(52) U.S. Cl. CPC H04W 40/24; H04W 48/16; H04W 40/248; H04W 8/005

(57) ABSTRACT

An apparatus for wireless communication is disclosed. The apparatus includes a processing system configured to generate a request for information about one or more neighboring wireless nodes; and an interface configured to output the request for transmission and, thereafter, obtain a response to the request. The processing system is further configured to filter, based on a response to the request, a list of network resources; and generate a report comprising the filtered list of network resources.

### BACKGROUND

### Field

Aspects of the present disclosure relate generally to wireless communication systems, and more particularly, to a method and apparatus for gathering network neighborhood information and generating a reduced neighbor report.

### Background

A wireless local area network (WLAN) connects two or more devices using radio waves. These devices may be categorized as being either an access point (AP) or a client, the latter also referred to herein as a client station or, simply, station (STA). A single service set consists of all STAs associated with a given AP and is referred to as a basic service set (BSS), with the most basic BSS configuration consisting of one AP and one STA. Multiple BSSs, using a common service set identifier (SSID), may form an extended service set (ESS). These BSSs may all operate using the same or different channels.

Typically, when a STA first enters into a physical local in which an ESS operates, the STA may detect a signal from several APs. Depending on its configuration, the STA may, manually or automatically, select an AP with which to associate, thereby joining a BSS managed by that AP. If that BSS is a part of a ESS, then the STA has effectively joined the ESS as well. The STA may need to change its association to another AP in the ESS for several reasons. For example, the STA may be mobile and may move out of a suitable signal range of one AP and into a signal range for a new AP. The STA would change its association to be with the new AP. As another example, the STA may also change its associate to be with a new AP if the STA determines that BSS of the new AP has fewer clients and therefore may support better performance.

During the time when the STA is associated with the AP, it may periodically receive a transmission from the AP containing information about other APs with which the STA may associate. These other APs, referred to as “neighboring APs”, may be advertised by the current AP with which the STA is associated in a list of neighboring APs, referred to as a “neighbor list”. The neighbor list may be advertised in an information element referred to as a “neighbor report.” The neighbor report enables the STA to collect information about neighboring APs so as to identify potential candidates for a new point of attachment for roaming or resource allocation purposes.

The neighbor report minimizes use of resources for both the STA and the network. For example, scan time for the STA that may be incurred to find suitable new APs for association may be reduced or eliminated. In addition, resource overhead attributable to the STA probing the network, which includes use of valuable resources such as airtime, may be reduced or eliminated. However, protocols such as those contained in the IEEE 802.11ai protocol do not specify how to obtain the information needed to generate a neighbor list for the neighbor report. Manual provisioning such a list is not practical because each STA may conceivably require a different list.

Further, it may not be efficient or even wasteful of network resources for the AP to broadcast a neighbor report with a neighbor list that includes all possible neighboring APs. For example, some neighboring APs may not be accepting new associations and including information about these neighboring APs in the neighbor report would be detrimental because of the wasted network resources necessary to transmit the information, not to mention the unnecessary energy expenditure needed by the STA to receive and process the information.

As the demand for wireless network access continues to increase, research and development continue to advance communications technologies not only to meet the growing demand for wireless network access, but to advance and enhance the user experience with mobile communications. Thus, it would be useful to address the issues presented above.

### SUMMARY

The following presents a simplified summary of one or more aspects of the disclosed approach, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In a particular example, an apparatus for wireless communication includes a processing system configured to generate a request for information about one or more neighboring wireless nodes; and an interface configured to output the request for transmission and, thereafter, obtain a response to the request. The processing system is further configured to filter, based on the response to the request, a list of network resources; and generate a report comprising the filtered list of network resources.

In another particular example, a method for wireless communication includes generating a request for information about one or more neighboring wireless nodes, outputting the request for transmission, and, thereafter, obtaining a response to the request. The method further includes filtering, based on the response to the request, a list of network resources; and generating a report comprising the filtered list of network resources.

In another particular example, an access point includes a processing system configured to generate a request for information about one or more neighboring wireless nodes. The access point further includes a transmitter configured to output the request for transmission, and a receiver configured to obtain a response to the request. The processing system is further configured to filter, based on the response to the request, a list of network resources; and generate a report comprising the filtered list of network resources.

In another particular example, an apparatus for wireless communication, includes means for generating a request for information about one or more neighboring wireless nodes. The apparatus further includes means for outputting the request for transmission and, thereafter, obtain a response to the request. The apparatus further means for filtering, based on the response to the request, a list of network resources; and means for generating a report comprising the filtered list of network resources.

In another particular example, a computer program product includes a computer-readable storage medium with code for generating a request for information about one or more neighboring wireless nodes, outputting the request for transmission, and, thereafter, obtaining a response to the request. The computer-readable storage medium further includes code for filtering, based on the response to the request, a list of network resources; and generating a report comprising the filtered list of network resources.

These and other aspects of the present disclosure will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a network diagram of an AP and a set of STAs associated therewith that may be used to describe various aspects of the disclosure for gathering and filtering network neighborhood information to generate a reduced neighbor report (RNR).

FIG. 2 is a call-flow diagram for an AP and an associated STA to gather and filter network neighborhood information involving a set of neighboring APs configured in accordance with various aspects of the disclosure for gathering and filtering network neighborhood information to generate an RNR.

FIG. 3 is a diagram of a Radio Measurement Request frame format that may be used to implement beacon report requests in accordance with various aspects of the disclosure.

FIG. 4 is a diagram of formats of various information elements and fields that may be contained in the Radio Measurement Request frame of FIG. 3.

FIG. 5 is a diagram of various information element formats for Request Elements and Extended Request Elements that may be contained in the Radio Measurement Request frame of FIG. 3 to implement various aspects of the disclosure for gathering and filtering network neighborhood information to generate a reduced neighbor report (RNR).

FIG. 6 is a flow diagram for generating an RNR based on an enhanced beacon reporting mechanism configured in accordance with various aspects of the disclosure for gathering and filtering network neighborhood information.

FIG. 7 is a flow diagram for an RNR generation process that includes a AP-side filtering operation based on an enhanced beacon reporting mechanism configured in accordance with various aspects of the disclosure for gathering and filtering network neighborhood information.

FIG. 8 is a flow diagram for an RNR generation process that includes a AP-directed STA-side filtering operation based on an enhanced beacon reporting mechanism configured in accordance with various aspects of the disclosure for gathering and filtering network neighborhood information.

FIG. 9 is a flow diagram for an RNR generation process that includes an autonomous STA-side filtering operation based on an enhanced beacon reporting mechanism configured in accordance with various aspects of the disclosure for gathering and filtering network neighborhood information.

FIG. 10 is a flow diagram for a neighbor report generation process based on an enhanced beacon reporting mechanism configured in accordance with various aspects of the disclosure for gathering, filtering, and publishing information about network resources.

FIG. 11 is a diagram of a wireless device that is operable to support various aspects of one or more methods, systems, apparatuses, and/or computer-readable media disclosed herein.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Those skilled in the art would understand that the term “station” in certain standards may refer to either access points (APs) or clients. As used herein the terms “station” or “STA” will be used in its singular or plural forms to refer to client stations unless otherwise noted. Further, the term “wireless node” may be used to refer to either APs or clients. In addition, although standards such as the IEEE 802.11 (802.11) standard provide for WLANs with no APs, referred to as an ad hoc wireless network, the discussion contained herein uses examples in which there is at least one AP.

IEEE 802.11ai (802.11ai) is related to fast initial link setup (FILS) and provides for neighborhood information, such as a neighbor report information element (IE), that can be transmitted by an AP in a beacon frame, a probe response frame, or a FILS discovery frame. Various aspects of the disclosure provide for efficient gathering of information necessary to generate a neighbor report. In one aspect of the disclosure, a beacon/radio measurement reporting mechanism such as that specified in the IEEE 802.11k (802.11k) standard may be used by an AP to gather information about neighboring APs from its associated STAs to create a neighbor report. In this beacon/radio measurement reporting mechanism, an AP may transmit a beacon report request to one or more associated STAs, to which each associated STA may respond with a beacon report. The information contained in all received beacon reports may then be used by the AP to construct a list of neighboring APs that is also referred to as a neighbor list. This neighbor list may then be broadcast by the AP in a neighbor report.

In addition, various aspects of the disclosure provide for reducing unnecessary network and STA resource use by creating a customized neighbor list, also referred to as a “customized list of neighboring APs” to generate (e.g., customize) an optimized neighbor report referred to as a “reduced neighbor report” (RNR). The customized neighbor list may thus refer to a partial list of neighboring APs from a larger list of neighboring APs. The customized neighbor list may be created from multiple lists of neighboring APs. In one aspect of the disclosure, a list of neighboring APs may be filtered (e.g., removing entries from the list) to create a filtered list of neighboring APs. The filtered list of neighboring APs may either be combined with other neighbor lists, such as other filtered list of neighboring APs, or undergo additional modification. As used herein, the term “customize” may refer to operations of filtering, removing, or otherwise modifying. Further, the term “customized list of neighboring APs” may be used to refer to a filtered list of neighboring APs, whether or not the filtered list of neighboring APs has been additionally modified. In one aspect of the disclosure, the AP may provide the filtering functionality. In another aspect of the disclosure, the associated STA may provide the filtering functionality. In still yet another aspect of the disclosure, both the AP and the associated STA may be involved in providing the filtering functionality. Various aspects of the filtering functionality as provided by the AP and/or the associated STA are further described herein.

Filtering the neighbor list to create a customized neighbor list for an RNR benefits STAs at several points of operation, such as during selection by a STA of a neighboring AP for association. In this case, being able to decrease the size of an RNR will reduce use of the RF front end (to receive the RNR) and processing (to evaluate the neighboring APs identified in the RNR) by the STA. Thus, the RNR may help the STA quickly (and in a power efficient manner) discover a suitable AP with which to associate. For example, 802.11ai provides a mechanism for STAs to select a suitable AP (whether the AP is being chosen for new association or roaming operations) based on a client security credentials. Thus, a STA may select an AP deployed by a first network operator (e.g., AT&T) instead of a nearby AP deployed by a second network operator (e.g., Verizon) if the STA has credentials for the first network operator. An AP may choose to advertise only neighboring APs that belong to the same security domain. In another example, an operator may want a customized neighbor list such that the RNR contains only the APs that belong to its network. In still another example, an AP may only advertise neighboring APs that have indicated that they are accepting new associations (for example, a neighboring AP may include a flag indicating that a “not accepting further associations” state is turned OFF). In addition, there could be other criteria that may be used to select which neighboring APs are identified in a customized neighbor list, as further described herein.

Filtering the neighbor list to create a customized neighbor list for an RNR also benefits the network as a whole. For example, a neighbor report may be transmitted through several means, such as from a Beacon frame, a FILS Discovery frame, Probe Response frame, or an Association/Re-association frame; all of which are management frames. Because management frames are transmitted at the lowest data rates for reliability, in certain situations the neighbor report mechanism may place a burden on network resources. For example, if there are a lot of neighboring APs (e.g., a crowded neighborhood) in the list of neighboring APs, then the neighbor report will be large, which will take up network resources (e.g., air time) to transmit. Decreasing the size of the neighbor list, which reduces the size of neighbor report, reduces air time occupancy/medium use by these management frames and frees up medium for more data transfer. In other words, being able to reduce the size of neighbor reports allows for smaller management frame sizes; freeing up more medium (air time) for data frames that are often transmitted a much higher data rates.

Various aspects of the disclosure may be extended to use other mechanism for achieving or extending the information gathering functionality provided by the beacon request/report mechanism. By way of example and not limitation, IEEE 802.11u provides a discovery mechanism referred to as “Access Network Query Protocol” (ANQP) that may also be used by a STA to collect information. In general, ANQP is a query and response protocol that may be used by a mobile device such as a STA to discover a range of access network information, including: an AP operator's domain name (a globally unique, machine searchable data element); roaming partners accessible via the AP along with their credential type and Extensible Authentication Protocol (EAP) method supported for authentication; IP address type availability (e.g., IPv4, IPv6); and other metadata useful in network selection process. Through the use of ANQP, a STA may query an AP for access network capabilities even if the STA is not associated with the AP. Thus, an AP may, in a beacon report request, include a request that an associated STA return information in a beacon report that has been acquired using ANQP. This information may then also be used to the AP to filter which neighboring APs are advertised in an RNR.

Although examples provided herein for describing various aspects of the disclosure use beacon report request frames and beacon report frames, those skilled in the art would understand how various aspects of the disclosure may be applied to other types of frames including, as non-limiting examples, association/reassociation-related frames and probe request/response-related frames. For example, the information gathering aspect of the AP may use other type of frames that are capable of carrying a query for information from the AP to a STA, including association/reassociation response frames, and probe response frames. Responses to these queries for information may use other types of frames that are capable of carrying information that is responsive to the query, including association/reassociation request frames and probe request frames.

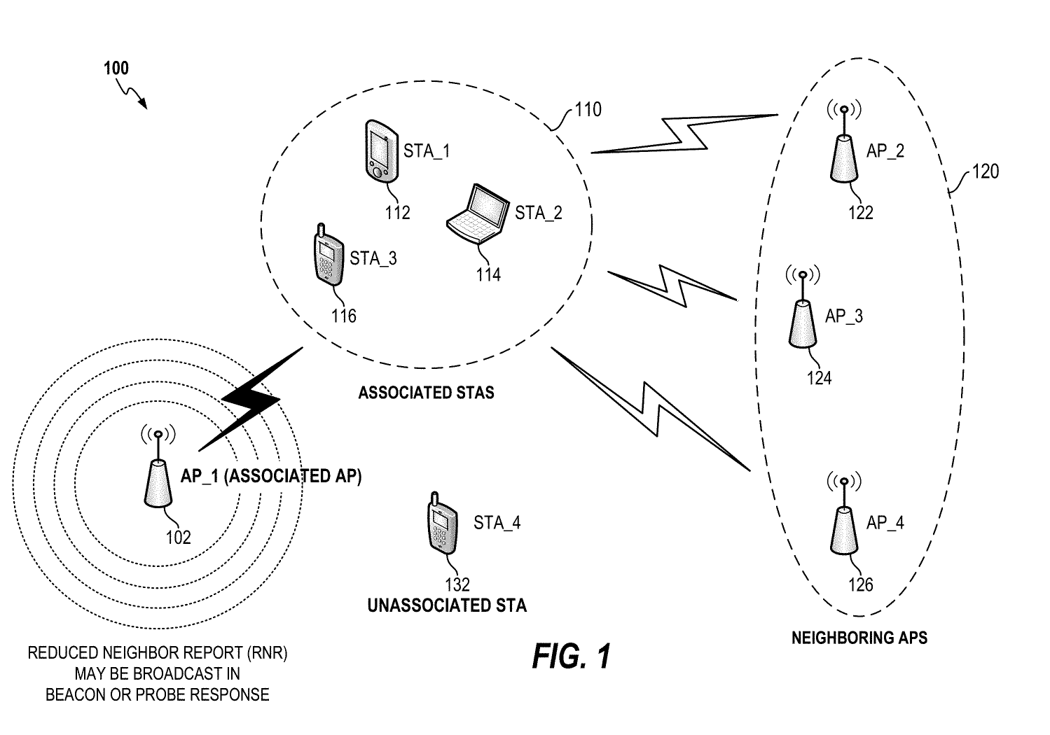

FIG. 1 illustrates an example network 100 in which the various aspects of the disclosure may be implemented. The network 100 includes a set of STAs 110 that is associated with an AP_1 102 (“associated AP”). The set of STAs 110, as illustrated, includes a STA_1 112, a STA_2 114, and a STA_3 116 (“associated STA(s)”). One or more STAs of the set of STAs 110 may be in communication with a set of neighboring APs (“neighboring APs”) 120, which as illustrated includes an AP_2 122, an AP_3 124, and an AP_4 126. The network 100 also includes an unassociated STA, illustrated as a STA_4 132.

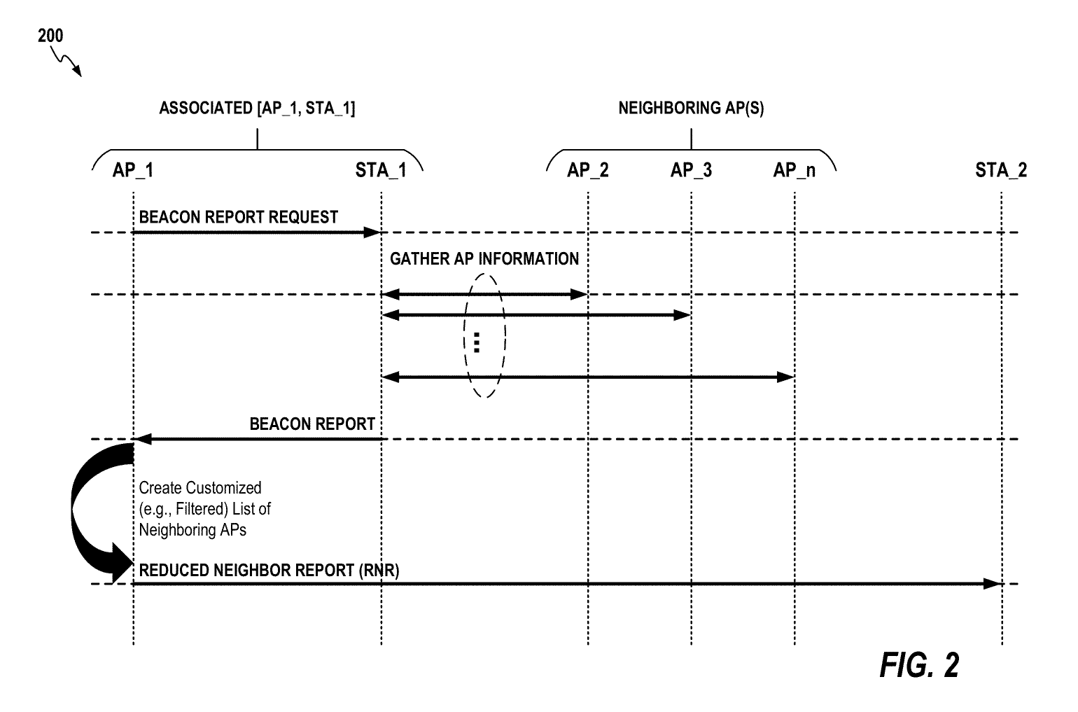

Various aspects of the disclosure will be described with reference to FIG. 2, which illustrates a call-flow 200 for an AP such as the AP_1 102 in FIG. 1 to generate an RNR by coordinating with an associated STA such as the STA_1 112. The AP_1 102 and the STA_1 112 are shown as AP_1 and STA_1 in FIG. 2, respectively. Neighboring APs such as the neighboring APs 120 in FIG. 1 are shown as AP_2, AP_3, and AP_n, where n represents an arbitrary number to note that the call-flow 200 may apply to any number of neighboring APs. In addition, it should be noted that although the AP_1 102 may have several STAs associated therewith, as illustrated in FIG. 1, only one STA (e.g., STA_1 112) will be used in the majority of the following description for the call-flow 200 in order to avoid unnecessarily complicating the example.

An initial portion of the call-flow 200 provides a description of operations at the AP_1 102 and the STA_1 112 to gather information about neighboring APs using a beacon request/report mechanism so that a list of neighboring APs may be generated. Additional information is gathered. In one aspect of the disclosure, the beacon request/report mechanism is leveraged so that additional information that may then be used to perform filtering and customization of the list of neighboring APs is also gathered. The examples using the beacon request/report mechanism provided herein will be described with reference to the beacon/radio measurement reporting mechanism of 802.11k. In general, 802.11k provides a technique for an AP and its associated STAs to gather information about neighboring APs. Specifically, the standard defines several radio measurement request/report mechanisms by which an AP could request an associated STA to gather such report. It is noted that APs and STAs participating in the Wi-Fi Alliance® “Managed Wi-Fi” program should also support IEEE 802.11k radio measurements.

At 202, the AP_1 102 transmits a beacon report request to the STA_1 112. In one aspect of the disclosure, the beacon report request is carried as an action frame configured in accordance with a Radio Measurement Action frame under 802.11k. As further detailed herein, the action frame includes such information gathering parameters for neighboring APs as identification of which channel(s) to scan, which type of mechanism is to be used to gather the information (i.e., passive, active, or beacon table), how the measurement is to be gathered (i.e., in parallel, fixed duration, etc.), and a Broadcast Service Set Identifier (BSSID) for which the information is to be gathered.

In one aspect of the disclosure, the AP_1 102 may use the information returned by the STA_1 112 in a beacon report to filter a list of neighboring APs, such as the list of neighboring APs returned in the beacon report, to create a customized list of neighboring APs to be included in an RNR. In another aspect of the disclosure, an optional field in the action frame, named “Optional Subelement” field, is leveraged so that parameters for gathering additional information may be specified by the AP_1 102 to allow further filtering and customization of the list of neighboring APs in the beacon report. For example, the Optional Subelement field may direct the STA_1 112 to gather security domain, vendor, and/or subnet information about each neighboring AP the STA_1 112 returns in the list of neighboring APs reported in the beacon report. In yet other aspect of the disclosure, the AP_1 102 may use the Optional Subelement field to direct the STA_1 112 to filter the list of neighboring APs returned by the STA_1 112 in the beacon report. The AP_1 102 may then create the customized list of neighboring APs

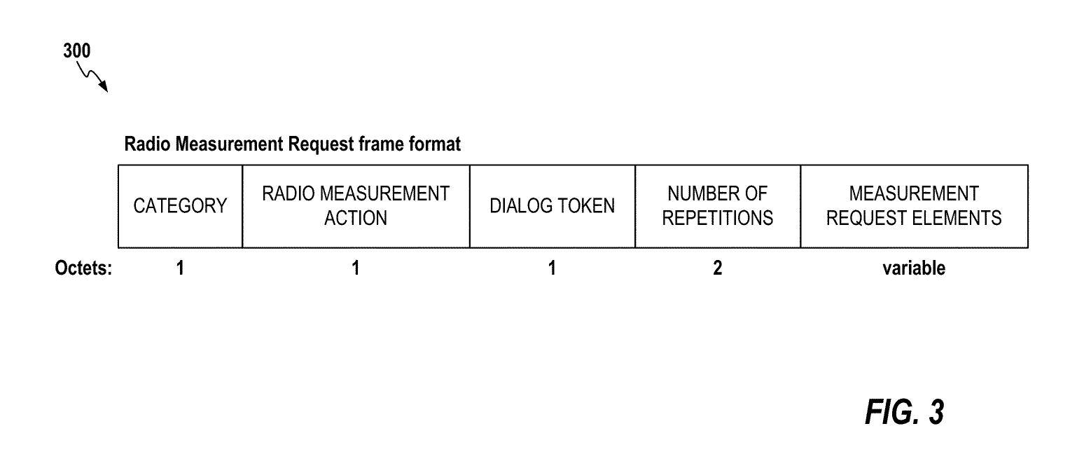

FIG. 3 illustrates a request frame format 300 that may be used for the Radio Measurement Action frame implementing a Radio Measurement Request frame that operates as the beacon report request under 802.11k. The Radio Measurement Request frame uses the Action frame body format and allows a wireless node such as an AP (e.g., the AP_1 102) to request another wireless node (e.g., the STA_1 112) make one or more measurements on one or more channels. The request frame format 300 includes a Category field 310 for indicating that the Radio Measurement Request frame is of a Radio Measurement category; a Radio Measurement Action field 320 for indicating which one of several Action frame formats, defined for Radio Measurement purposes, is being used; a Dialog Token 330 that includes a non-zero value set by the AP to identify the Radio Measurement Request frame; and a Number of Repetitions field 340 for indicating a requested number of repetitions for all the Measurement Request elements in the Radio Measurement Request frame (e.g., a single iteration of all the Measurement Request elements, multiple iterations, or continuous iterations until the measurement is cancelled or superseded).

The request frame format 300 also includes one or more Measurement Request Elements 350, each of which may be an information element for specifying the same or different type of measurement request, as further detailed herein. In other words, a Radio Measurement Request frame may contain a single Measurement Request information element, which may be referred to herein simply as “Measurement Request element”, or a sequence of Measurement Request elements.

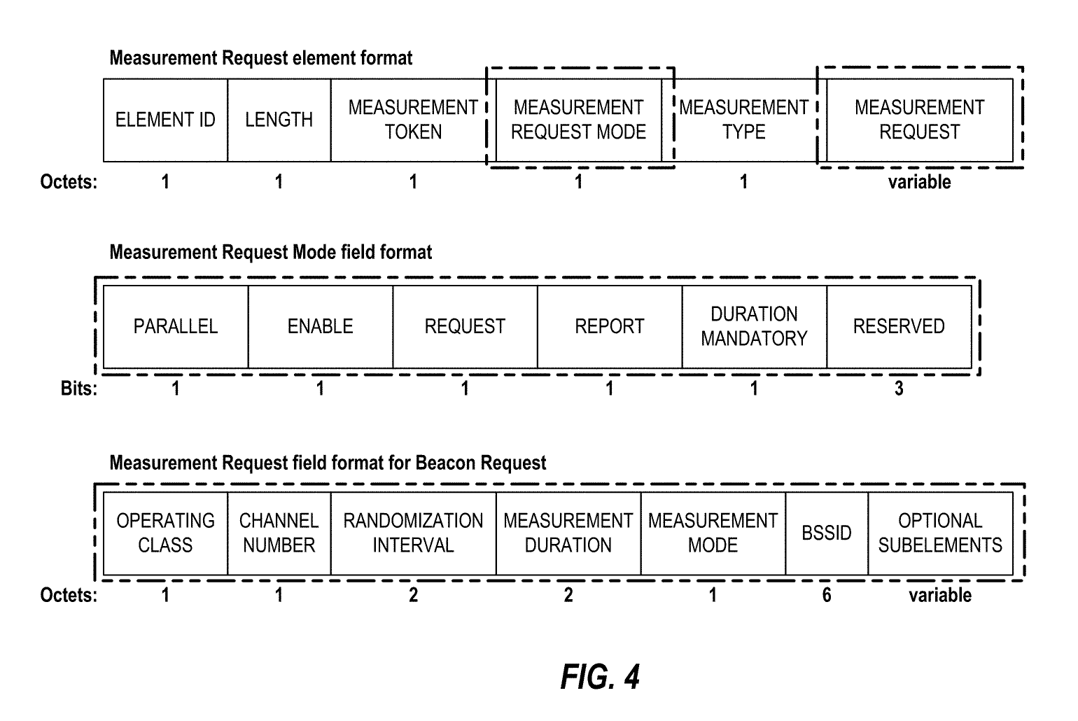

FIG. 4 illustrates a Measurement Request Element format 400 that may be used for each of the Measurement Request Elements 350 included in a particular beacon report request. The Measurement Request Element format 400 includes an Element ID field 402, a Length field 404, a Measurement Token field 406, a Measurement Request Mode field 408, a Measurement Type field 410, and a Measurement Request field 412. The Element ID field 402 allows a receiving STA to identify the Measurement Request Element as a Measurement Request information element. The Length field 404 depends on the length of the Measurement Request field 412. The Measurement Token field 406 is set to a nonzero number that is unique among the Measurement Request elements sent in a particular Measurement Request frame. The Measurement Type field 410 is set to a number that identifies a type of measurement request or a measurement report, which in this case is a beacon report request. The Measurement Request Mode field 408 and the Measurement Request field 412 are further described herein with reference to a Measurement Request Mode field format 430 and a Measurement Request field format 450, respectively.

Continuing to refer to FIG. 4, the Measurement Request Mode field format 430 that details the Measurement Request Mode field 408 is illustrated. The Measurement Request Mode field format 430 provides for a single octet (i.e., 8-bit) field that includes bits to manage how measurements should be performed for the measurement parameters indicated by a particular Measurement Request element in the Measurement Request Elements 350. Specifically, the Measurement Request Mode field format 430 includes: a Parallel bit 432 for indicating, where there are multiple measurement request elements, whether measurements described by each measurement request element should be performed in parallel; an Enable bit 434 for indicating whether the AP is requesting the STA to carry out beacon request measurements; a Request bit 436 for enabling/disabling Measurement Requests (reserved when the value in the Enable bit 434 is a “0”); a Report bit 438 for indicating whether the STA should send autonomous or triggered measurement reports (reserved when the value in the Enable bit 434 is a “0”); a Duration Mandatory bit 440 for indicating whether a requested duration for a measurement is mandatory, as further described herein; and a Reserved portion 442 of three (3) bits.

Further referring to FIG. 4, the Measurement Request field format 450 that details the Measurement Request field 412 for a beacon report request is illustrated. A length of each field in the Measurement Request field format 450, specified in octets, is shown below each field. As noted above, the Measurement Request element contains a request that the STA receiving the Radio Measurement Request frame undertake the specified measurement action. In the case where the Measurement Request field format 450 includes an Operating Class field 452 that is used for indicating a channel set for which the Measurement Request applies; a Channel Number field 454 for indicating the channel number for which the measurement request applies; a Randomization Interval field 456 for specifying an upper bound of the random delay to be used prior to making the measurement, specified in time units (TU) (1,024 microseconds); a Measurement Duration field 458 for setting a preferred or mandatory duration of the requested measurement; a Measurement Mode field 460 indicates the mode to be used for the measurement; and a BSSID field 462 for indicating the BSSID of the BSS(s) for which a beacon report is requested.

The Measurement Request field format 450 also includes an Optional Subelements field 464 that may be used by the AP_1 102 to specify additional parameters related to additional information to be gathered and reported by the STA_1 112 in one aspect of the disclosed approach. The additional information requested from the STA_1 112 may be used by the AP_1 102 to filter a list of neighboring APs returned that is also returned in the beacon report. In another aspect of the disclosure, the AP_1 102 may use the Optional Subelements field 464 to request the STA_1 112 filter the list of neighboring APs returned in the beacon report. In still another aspect of the disclosure, the STA_1 112 may by requested by the AP_1 102 to autonomously filter the list of neighboring APs returned in the beacon report. For example, the AP_1 102 may include an information element in the Optional Subelements field 464 of a beacon request to indicate if a filtering mode in the STA_1 112 should be “ON”.

In general, in accordance with various aspect of the disclosure, various indications in the Optional Subelements field 464 may be used by the AP_1 102 to affect the operation of the STA_1 112 in how the STA_1 112 responds to a beacon report request. An indication may be carried in a Request Element (as further described herein), a Vendor Specific field (e.g., in a proprietary implementation), or, further, be standards-defined.

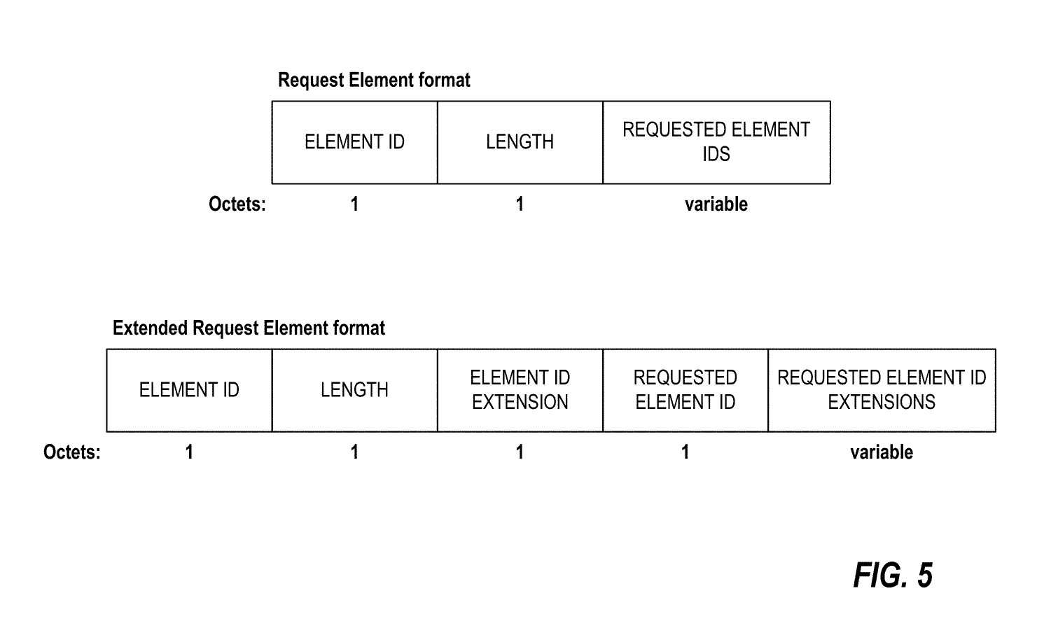

FIG. 5 illustrates a Request Element format 500 that may be used for a Request Element information element that is placed in the Optional Subelements field 464 by the AP_1 102. The Request Element format 500 includes an Element ID field 502 for indicating that the element is a Request Element; a Length field 504 for indicating the length of the Request Element; and a Requested Element IDs field 510. The Requested Element IDs field 510 identifies a list of elements that are requested by the AP_1 102. These elements may be related to information requested from the STA or actions requested by the AP. For example, the AP_1 102 may use the Requested Element IDs field 510 to request particular information about neighboring APs that the STA_1 112 may return in a beacon report. The information may then be used to filter and create a customized list of neighboring APs for use in an RNR. The Requested Element IDs field 510 may also be used by the AP_1 102 to affect the behavior of the STA_1 112. For example, the AP_1 102 may request the STA_1 112 perform filtering of which neighboring APs is included in a list of neighboring APs before that list is return in a beacon report. The STA_1 112 may filter the report autonomously or by using filtering criteria provided by the AP_1 102.

Continuing to refer to FIG. 5, an Extended Request Element format 550 that may be used for extending the Request Element information element provided by the Request Element format 500 is illustrated. Similar to the Request Element, the Extended Request Element may be placed in the Optional Subelements field 464 by the AP_1 102. The Extended Request Element format 550 includes an Element ID field 552 and an Element ID Extension field 556 that together are used for indicating that the element is an Extended Request Element; and a Length field 554 for indicating the length of the Extended Request Element. The Extended Request Element format 550 also includes a Requested Element ID field 558 that contains one of the Element IDs used to indicate an extended element; and a Requested Element ID Extensions field 560 that contains a list of 1-octet element ID extension values that, combined with the value of the Requested Element ID field 558, identify elements requested by the AP_1 102. These elements may be related to information requested from the STA or actions requested by the AP, as described for the Request Element information element, above.

Unless otherwise noted herein, an information element configured in accordance with either the Request Element format 500 or the Extended Request Element format 550 may be referred to as a “Request Element” or “custom request element”.

Although a discussion of every detail of the Radio Measurement Request frame under 802.11k is beyond the scope of this disclosure, all relevant aspects of a request frame configured with the request frame format 300 will be described herein to implement a beacon report request. For example, the Radio Measurement Action field 320 will have a value of “0” to indicate that the request frame an 802.11k Radio Measurement Request. The Measurement Type field 410 of the Measurement Request element format 400, which indicates one of the many request types, is set to “5” to indicate that the action frame is an 802.11k beacon request type of the 802.11k Radio Measurement Request to implement the beacon report request. It is submitted that those skilled in the art would be able to determine values for fields and information elements not specifically detailed herein.

An example of key values for a request frame (Radio Measurement Request frame) for implementing a beacon request report using the request frame format 300 (including the fields and information elements shown in FIG. 4) may be configured as follows:

### Radio Measurement Request Frame Configuration Example:

Radio Measurement Action: 0 (Radio Measurement Request)
Number of Repetitions: 1 (repeat once—i.e., take 2 measurements; dot11RRMRepeatedMeasurementsEnabled flag should be set to “true” for this to work)
Measurement Request Element:
   Measurement Request Mode:
      Parallel bit: 0 (perform measurement in sequence—this should not matter since for populating neighborhood list, the AP should be requesting Beacon Request measurements only)
      Enable bit: 0 (indicates that AP is requesting STA to perform Beacon Request measurements)
      Request bit: Reserved (when Enable=0)
      Report bit: Reserved (when Enable=0)
      Duration Mandatory bit: 0 (indicating that the duration requested is a maximum duration, and the requesting AP will accept measurement results taken over any shorter duration)
   Measurement Type=5 (Beacon Request measurement)
   Measurement Request:
      Operating Class: (country dependent)
      Channel Number: 0 (scan all channels)
      Randomization Interval (RI): =50 TU×no. of measuring STA (each STA will start measurement at a random time between 0 to RI to avoid traffic storms that could arise with synchronized group addressed measurements)
      Measurement Duration: 1000 TU
      Measurement Mode: 1 (active measurement)
      BSSID: ABSENT (request a wildcard BSSID search)
      Optional Subelements:
         SSID (ID=0): ABSENT (request a wildcard SSID search)
         Beacon Reporting Information (ID=1): ABSENT (request a beacon report to be issued after each measurement)
         Reporting Detail (ID=2): ABSENT (all fixed length fields and elements are requested in any beacon report)
         Request Element (ID=10): SSID (Request IE ID=0) and FILS Indication (Request IE ID=240)
         Extended Request Element (ID=255, ID Extension=20): Example Custom Parameter (Extended Request IE ID=34)
         AP Channel Report (ID=51): Not set since Channel Number set to 0

In the provided example, the AP_1 102 is requesting that the STA_1 112 provide SSID (Request IE ID=0) and FILS Indication (Request IE ID=240) information in any returned beacon reports by specifying these parameters in the Request Element (ID=10) placed in the Optional Subelements field 464. In addition, an example for including a custom extended request parameter in the Optional Subelements field 464 is also shown as an Extended Request Element (ID=255, ID Extension=20) that includes an Example Custom Parameter (Extended Request IE ID=34).

At 204, the STA_1 112, in response to the beacon report request, may begin to gather information from APs with which the STA_1 112 can communicate.

Specifically, where the STA_1 112 is an 802.11ai STA, the STA_1 112 will carry out the requested measurements as specified in the beacon report request when the STA_1 112 receives a Radio Measurement request. As described below, the STA_1 112 will provide a measurement report to the AP_1 102 in the form of a beacon report once the STA_1 112 is done with the measurements. However, if the value in the Number of Repetitions field from the request is a non-zero value, the STA_1 112 will generate and send a beacon report after each measurement. Thus, there may be multiple iterations of the measurement and reporting portions of the call-flow 200. In one aspect of the disclosure, the STA_1 112 may gather information in a passive manner by listening for any frames that may be broadcast by a neighboring AP. In another aspect of the disclosure, the STA_1 112 may gather information in an active manner such as, for example, by transmitting a probe request to neighboring APs.

At 206, once the STA_1 112 has gathered information about the neighboring APs, the STA_1 112 may transmit a response to the beacon report request from the AP_1 102 in the form of a beacon report. Under 802.11k, the beacon report may be implemented as an Action frame. Specifically, the beacon report may be implemented as a Radio Measurement Report frame, which may be indicated as such by using Beacon Report Type (5) in a Radio Measurement Action field in the Radio Measurement Report frame. Again, it is submitted that those skilled in the art would be able to configure beacon reports in light of the description provided herein.

At 208, by leveraging beacon report requests under the 802.11k beacon request/report mechanism, various aspects of the disclosure provide for customization of a list of neighboring AP that would be included in an RNR. In one aspect of the disclosure, the AP (e.g., the AP_1 102) may configure a beacon report request to affect the behavior of the associated STA (e.g., the STA_1 112) in gathering information about neighboring APs to generate a beacon report responsive to the beacon report request, whereby the AP may then perform filtering of the neighboring APs for inclusion in an RNR (i.e., filtering at AP). In another aspect of the disclosure, a beacon report request may be configured to allow the AP (e.g., the AP_1 102) to affect the behavior of the associated STA (e.g., the STA_1 112) during generation of the beacon report by the associated STA to filter a list of neighboring APs reported therein, whereby the filtering of the list of neighboring APs would effectively occur at the associated STA (filtering at STA, as controlled by AP). In still another aspect of the disclosure, the associated STA (e.g., the STA_1 112) may autonomously determine which neighboring APs are reported during generation of the beacon report such that the list of neighboring APs in the beacon report are filtered by the associated STA (autonomous STA filtering). In accordance with various aspects of the disclosure, a customized list of neighboring APs may be constructed using results of any filtering operations described herein, and the customized list of neighboring APs may then be used in an RNR.

Various aspects of the disclosure for performing filtering operations are described with reference to three examples provided herein. Reference is also made to the provided description related to FIG. 3 and also FIG. 4 for examples of how a beacon report request frame may be configured to allow the AP_1 102 to request the STA_1 112 report information necessary for performing the filtering operations.

Example 1 (filtering on AP side): The AP_1 102 may transmit a beacon report request frame using the request frame format 300 containing a Measurement Request that includes element IDs in the Optional Subelements field 464 for specific elements that the AP_1 102 would like the STA_1 112 to report. For example, if the AP_1 102 wishes to filter neighboring APs based on one or more security domains to which these neighboring APs belong, the AP_1 102 shall request the STA_1 112 gather and report FILS Indication element (Subelement ID=10) or Mobility Domain for each of the neighboring APs that the STA_1 112 sees in the neighborhood. The AP_1 102 shall then filter and include only the neighboring APs that belong to a certain security domain in the RNR. Similarly, the AP_1 102 may request the STA_1 112 report neighboring APs that belong to a certain subnet or other criteria. Such a scheme is compliant with specifications such as the 802.11 standard and thus may work with STAs belonging to any vendor.

Example 2 (filtering on STA side): The AP_1 102 may transmit a beacon report request frame configured to request that the STA_1 112 only reports neighboring APs that match certain criteria. For example, the AP_1 102 may use a Vendor Specific field (Subelement ID=221) in the Optional Subelements field 464 of the beacon report request frame to signal to the STA_1 112 that the STA_1 112 should filter the reported neighboring APs based on certain criteria (e.g., neighboring APs that belong to a particular security domain or subnet ID, or matching other criteria). In one aspect of the disclosure, the Vendor Specific field may carry the necessary sub-fields that signal this value (e.g., Domain name or SubnetID Token, etc.). In one aspect of the disclosure, the STA_1 112 would be a client device that belongs to the vendor, and would parse the Vendor Specific field in the Optional Subelements field 464 of the beacon report request frame, and filter and then report only those neighboring APs that satisfies the specified criteria. Such a scheme may not be compliant with standards such as the IEEE standard and may work only between APs/STAs that implement this feature.

Example 3 (autonomous filtering at the STA): In this approach, the STA_1 112 may autonomously filter, and subsequently report, neighboring APs without needing filtering parameters in a beacon report request frame from the AP_1 102. For example, the STA_1 112 may report only neighboring APs that closely match the operating parameters of the AP_1 102, such as those belong to the same security domain or same subnet ID (or both). In addition to these specific criteria, the STA_1 112 may only report those neighboring APs in the same ESS as the AP_1 102. Such a scheme could be either proprietary or standards-defined behavior.

At 210, once the filtering operation has been completed at 208, a customized list of neighboring APs may be generated and then transmitted in an RNR. In one aspect of the disclosure, the RNR may be broadcast in a beacon. In another aspect of the disclosure, the RNR may be sent in response to a probe from another STA. It should be noted that although the RNR may benefit STA_1 112, which is the client that has collected the information for some or all of the neighboring APs in the RNR, the RNR may benefit other clients associated with the AP_1 102 (e.g., the other STAs in the set of STAs 110 in FIG. 1). Where there are multiple associated clients providing information, the RNR may benefit all of these STAs because not all of them may have obtained the same information. Consequently, the cumulative information contained in—and filtered using—all the responses to the request by the AP_1 102 most likely includes relevant information not acquired by some of the associated clients that receive the RNR. In addition to benefiting the STAs that are associated with the AP_1 102, the RNR may benefit clients that are not unassociated with the AP_1 102 because, by using information in the RNR, those STAs may be able to acquire relevant information about the neighboring APs in the RNR immediately, even before attempting to associate with the AP_1 102.

Continuing to refer to FIG. 2, another STA, which is illustrated as “STA_2”, may receive the RNR. The STA_2 may be another STA that is associated with the AP_1 102, in which case the STA_2 may use the information contained therein for roaming or associating with one of the APs identified therein. Alternatively, if the STA_2 is unassociated with the AP_1 102, the STA_2 may still utilize the information contained in the RNR to determine with which AP to associate. For example, the STA_2 may decide not to request association with AP_1 102 but instead request association with one of the neighboring APs identified in the neighbor list in the RNR. The STA_2 may even determine, using the information it acquires from the RNR, that it does not want to request association with either the AP_1 102 or any of the neighboring APs in the neighbor list, but instead the STA_2 may determine that it will request association with another AP.

Although some examples of criteria, capabilities, characteristics, and/or parameters (including operational/operating criteria, capabilities, characteristics, and/or parameters) related to wireless nodes such as neighboring APs have been provided, these examples should not be limiting. Other examples may include: security domain, mobility domain, network/IP subnet, capacity parameter, new association availability (i.e., whether the AP accepts requests for a new association), channel occupancy (e.g., at or below certain threshold), estimated air-time, target wake time schedule, vendor identification, communications frequency spectrum, protocol capability, and access capability. The examples are not meant to be exhaustive and those skilled in the art would understand that other criteria, capabilities, characteristics, and/or parameters may be encompassed by various aspects of the disclosure.

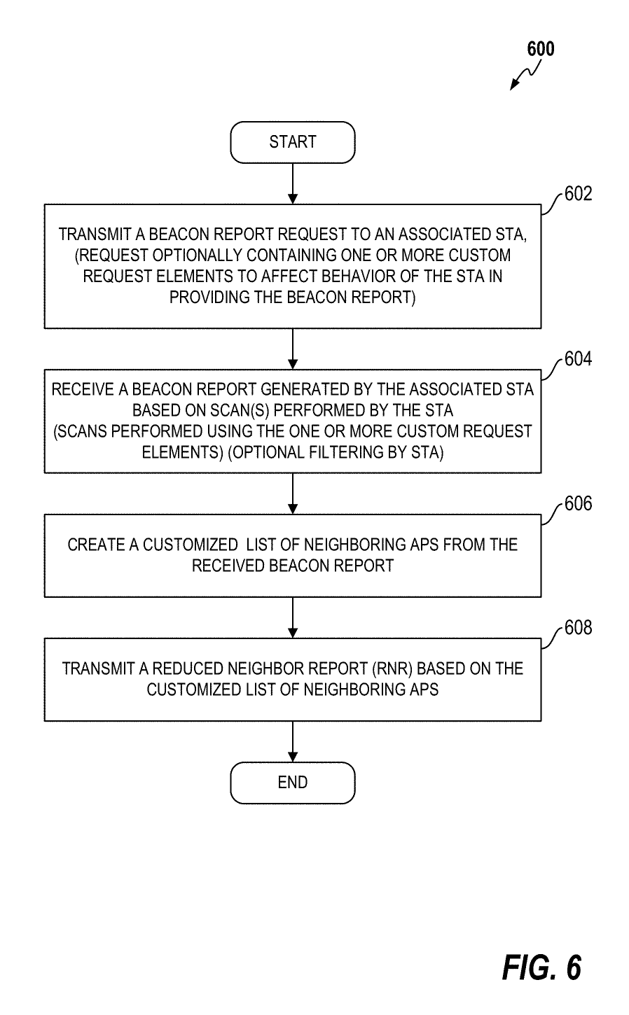

FIG. 6 illustrates an RNR generation process 600 that utilizes an enhanced beacon reporting mechanism involving an AP and an associated STA to gather and filter information about network resources, such as neighboring APs, to create an RNR. In some aspects, the operation of the RNR generation process 600 parallels various portions of the call-flow 200 described in FIG. 2, above, with respect to how information about network resources may be filtered. For example, information about network resources such as a list of neighboring APs that would be included in the RNR may be filtered. More specifically, the RNR generation process 600 is a general example of an operation where filtering of the neighbor list of neighboring APs may be performed by the AP or the associated STA, such as those described by the filtering examples provided in FIG. 2. Examples of the AP and the associated STA may be found as the AP_1 102 and the STA_1 112, respectively, from FIG. 1.

At 602, the AP transmits a beacon report request to the associated STA to acquire information about neighboring APs with which the associated STA may communicate. The associated STA thus may return a list of neighboring APs in a beacon report in response to the beacon report request.

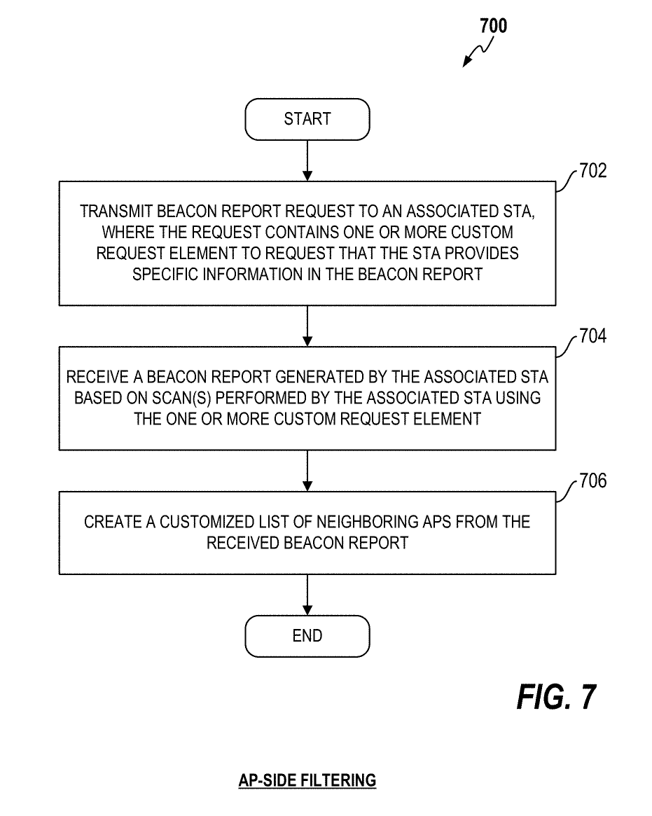

In one aspect of the disclosed approach, the beacon report request sent by the AP may optionally include one or more custom request elements to affect behavior of the associated STA in gathering information about network resources for providing the beacon report. For example, what information is gathered by the associated STA when scanning for neighboring APs may be affected by the one or more custom request elements. In addition, how the associated STA scans for neighboring APs may be affected by the one or more custom request elements. A detailed description of this aspect is provided by an example in the description for FIG. 7, below.

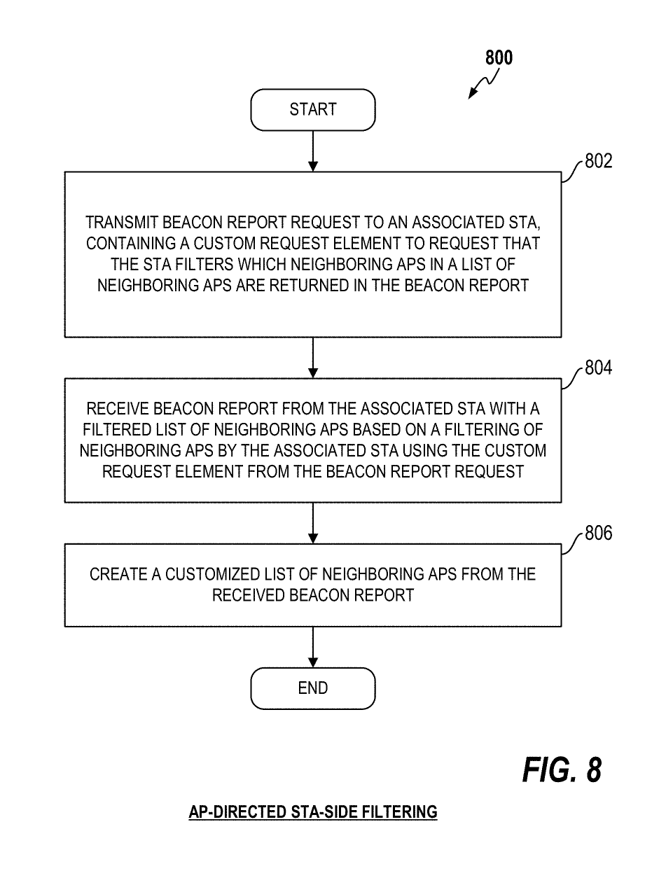

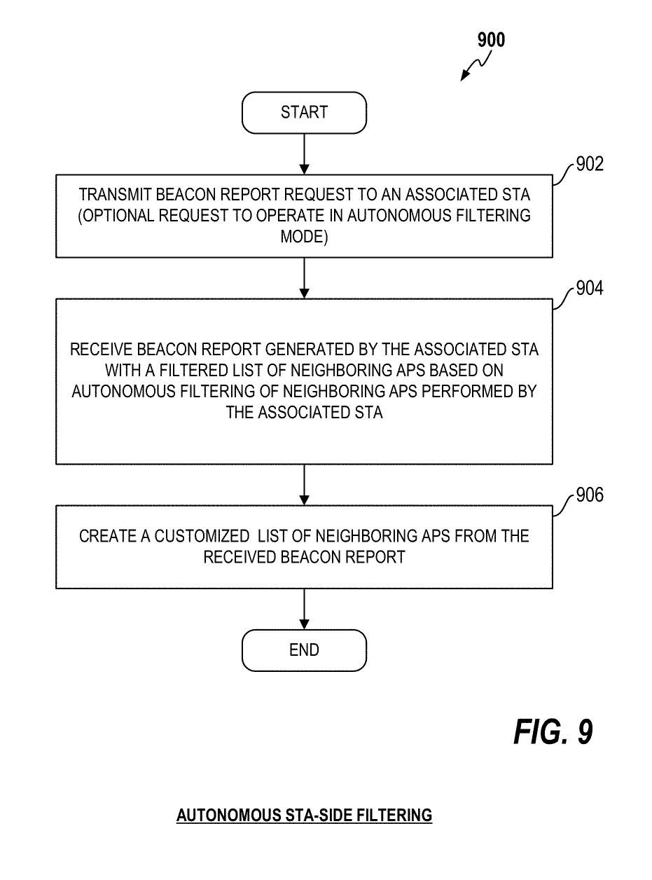

At 604, a beacon report is received from the associated STA by the AP. In one aspect of the disclosure, as described for 602, the beacon report is generated by the associated STA based on information gathered about neighboring APs using the one or more custom request elements in the beacon report request from the AP. In another aspect of the disclosure, the associated STA may filter any information gathered for the beacon report, such as the neighboring APs that may be included in the list of neighboring APs, before the beacon report is generated by the associated STA. In the latter aspect, the AP may affect how the associated STA filters information about network resources for the beacon report, or the STA may perform autonomous filtering. More details are provided with reference to FIG. 8, where an example of the AP affecting how the associated STA filters information about network resources for the beacon report is provided; and FIG. 9, where an example of the associated STA performing autonomous filtering is provided.

At 606, the AP may create a customized list of neighboring APs based on the information contained in the beacon report. In the aspect of the disclosure where the AP performs filtering, the AP may create the customized list of neighboring APs by filtering the list of neighboring APs from the beacon report based on the information returned in the beacon report by the associated STA. In the other aspects of the disclosure where the associated STA performs filtering, the customized list of neighboring APs may be directly based on the list of neighboring APs contained in the beacon response because the list of neighboring APs contained therein has already been filtered by the associated STA. However, the AP may still perform additional filtering of the list of neighboring APs to create the customized list of neighboring APs. In addition, the AP may include other neighboring APs in the customized list of neighboring APs based on beacon reports previously received from the associated STA and/or beacon reports from other associated STAs. Moreover, the AP may include neighboring APs from other lists of neighboring APs, such as those stored on the AP, in the customized list of neighboring APs. Thus, although the various examples described herein may refer to the “creation” or “generation” of a customized list of neighboring APs by the AP from beacon reports, it should be understood by those skilled in the art that a customized list of neighboring APs may be created by using one or more lists of neighboring APs from various sources, including those that may already exist on the AP.

At 608, the AP may transmit an RNR that contains a list of neighboring APs based on the customized list of neighboring APs.

FIG. 7 illustrates an AP-side filtering process 700 that utilizes an enhanced beacon reporting mechanism involving an AP and an associated STA to gather and filter information about network resources, such as neighboring APs, that may be used for generating an RNR. In some aspects, the operation of the AP-side filtering process 700 parallels various portions of the call-flow 200 described in FIG. 2, above, with respect to how information about network resources may be filtered. For example, a network resource such as a list of neighboring APs that would be included in the RNR may be filtered. More specifically, the AP-side filtering process 700 is a general example of an operation where, after the AP sends the associated STA a beacon report request and then receives a beacon report from the associated STA that contains a list of neighboring APs in response thereto, filtering of the list of neighboring APs to include in the RNR is performed by the AP. In other words, a filtering operation may be performed by the AP using information contained in the beacon report received from the associated STA to reduce the number of neighboring APs contained in the list of neighboring APs, which ultimately will result in a reduced list of neighboring APs that would have to be advertised in a neighbor report (i.e., the RNR). Examples of the AP and the associated STA may be found as the AP_1 102 and the STA_1 112, respectively, from FIG. 1.

At 702, the AP transmits a beacon report request to an associated STA, where the request contains one or more custom request elements in an optional subelement field to request that the associated STA provides specific information in a beacon report. For example, the AP may include one or more Request Elements in the Optional Subelements field 464 of the beacon report request to request specific information in the beacon report from the associated STA.

At 704, the AP receives a beacon report generated by the associated STA based on scan(s) performed by the STA using one or more custom request elements as requested by the AP in the beacon report request.

At 706, the AP filters the list of neighboring APs from the received beacon report and creates a customized list of neighboring APs. The neighboring APs in the customized list of neighboring APs may then be advertised in the RNR.

FIG. 8 illustrates an AP-directed STA-side filtering process 800 that utilizes an enhanced beacon reporting mechanism involving an AP and an associated STA to gather and filter information about network resources, such as neighboring APs, that may be used for generating an RNR. In some aspects, the operation of the AP-directed STA-side filtering process 800 parallels various portions of the call-flow 200 described in FIG. 2, above, with respect to how information about network resources may be filtered. For example, a network resource such as a list of neighboring APs that would be included in the RNR may be filtered. More specifically, the AP-directed STA-side filtering process 800 is a general example of an operation where filtering of the list of neighboring APs may be performed by the associated STA under the direction of the AP through the use of a beacon report request communicated by the AP to the associated STA. In one aspect of the disclosure, the AP may direct how the associate STA filters the list of neighboring APs returned in a beacon report by including one or more parameters in the beacon report request. Examples of the AP and the associated STA may be found as the AP_1 102 and the STA_1 112, respectively, from FIG. 1.

At 802, the AP transmits a beacon report request to the associated STA, where the beacon report request contains a custom request to direct that the associated STA filters neighboring APs so that only neighboring APs having certain characteristics are returned in a response provided by the associate STA. The custom request may be specified by the AP including one or more Request Elements in the Optional Subelements field 464 of the beacon report request. In addition, the AP may request the associated STA perform filtering using one or more custom request elements in the custom request.

At 804, the AP receives a beacon report with a list of neighboring APs generated by the associated STA based on a filtering performed by the STA of neighboring APs. In other words, the AP receives a filtered list of neighboring APs. The filtering may be performed by the STA based on the custom request specified by one or more Request Elements contained in the Optional Subelements field 464.

At 806, the AP creates a customized list of neighboring APs from the filtered list of neighboring APs in the received beacon report. The neighboring APs in the customized list of neighboring APs may then be advertised in an RNR.

FIG. 9 illustrates an autonomous STA-side filtering process 900 that utilizes an enhanced beacon reporting mechanism involving an AP and an associated STA to gather and filter information about network resources, such as neighboring APs, that may be used for generating an RNR. In some aspects, the operation of the autonomous STA-side filtering process 900 parallels various portions of the call-flow 200 described in FIG. 2, above, with respect to how information about network resources may be filtered. For example, network resources such as a list of neighboring APs that would be included in the RNR may be filtered. More specifically, the autonomous STA-side filtering process 900 is a general example of an operation where, in response to a beacon report request sent by the AP, the associated STA sends a beacon report with a filtered list of neighboring APs. In aspect of the disclosure, the associated STA autonomously filters which neighboring APs seen by the associated STA are included in the list of neighboring APs returned to the AP in the beacon report based on certain criteria determined by the associated STA. Thus, the associated STA controls which neighboring APs are identified in beacon reports returned to the AP. Examples of the AP and the associated STA may be found as the AP_1 102 and the STA_1 112, respectively, from FIG. 1.

At 902, the AP transmits a beacon report request to the associated STA. In one aspect of the disclosure, as discussed above, the beacon report request may request that the associated STA operate in an autonomous filtering mode. For example, the AP may include a Request Element in the Optional Subelements field 464 of the beacon report request to indicate whether the STA_1 112 should be in a “filtered” mode or a “report all” mode. Thus, the AP_1 102 may be allowed to request that the STA_1 112 perform filtering functions without having to specify any particular search parameters.

At 904, the AP receives a beacon report containing a filtered list of neighboring APs that is generated by the associated STA based on a filtering of neighboring APs that is autonomously performed by the associated STA. In one aspect of the disclosed approach, the filtering of the neighboring APs by the associated STA may be based on one or more operating characteristics of the associated AP that transmitted the beacon report request. For example, the associated STA may perform filtering of the neighboring APs to restrict the neighboring APs in the filtered list of neighboring APs to only those having a similar security domain.

At 906, the AP creates a customized list of neighboring APs from the filtered list of neighboring APs received in the beacon report from the associated STA. The neighboring APs in the customized list of neighboring APs may then be advertised in an RNR.

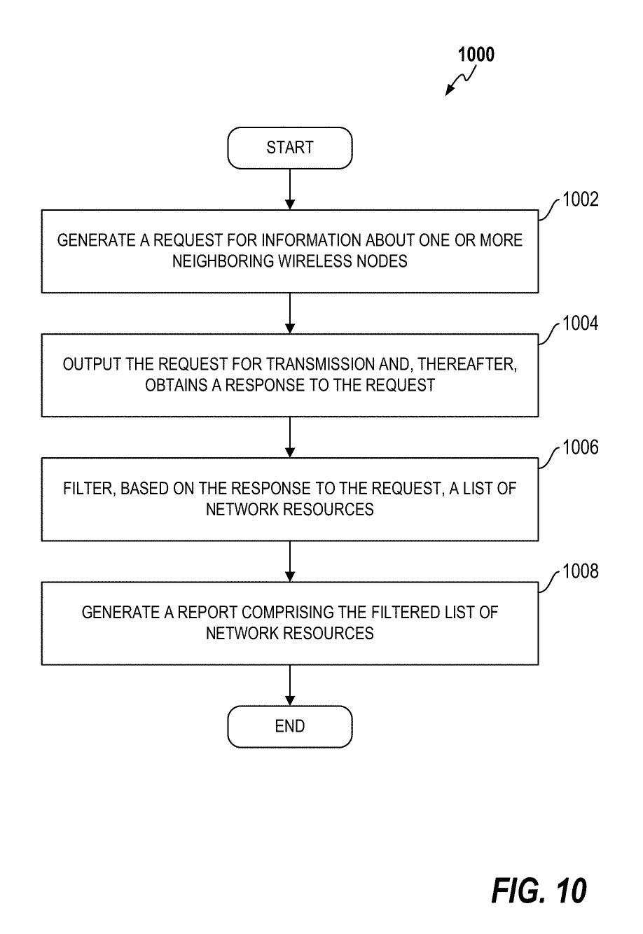

FIG. 10 illustrates a neighbor report generation process 1000 that utilizes an enhanced beacon reporting mechanism implemented by an AP to gather information about network resources using a wireless node such as an associated STA. Examples of the AP and the associated STA may be found as the AP_1 102 and the STA_1 112, respectively, from FIG. 1. In some aspects, the operation of the neighbor report generation process 1000 parallels the call-flow 200 described in FIG. 2, above.

At 1002, the AP generates a request for information about one or more neighboring wireless nodes.

At 1004, the AP outputs the request for transmission and, thereafter, obtains a response to the request.

At 1006, the AP filters, based on the response to the request, a list of network resources. Various aspects of how the AP may filter the list of network resources have been described herein. In one aspect of the disclosure, the list of network resources may be a list of neighboring APs. In another aspect of the disclosure, the list of network resources may be indirectly related to the neighboring APs. For example, the list of network resources may be the list of available capacity at each neighboring AP, which may be a subset of all neighboring APs.

At 1008, the AP generates a report comprising the filtered list of network resources. The filtered list of network resources may be a filtered list of neighboring APs, such as the various customized list of neighboring APs described herein. In one aspect of the disclosure, this neighbor report is an RNR that may be received by a second wireless node such as another STA. This other STA may thus benefit from the information gathered by the associated STA. In addition, this other STA does not have to be associated with the AP. As such, this other STA may have received the RNR based on the AP broadcasting it in a transmission such as a beacon.

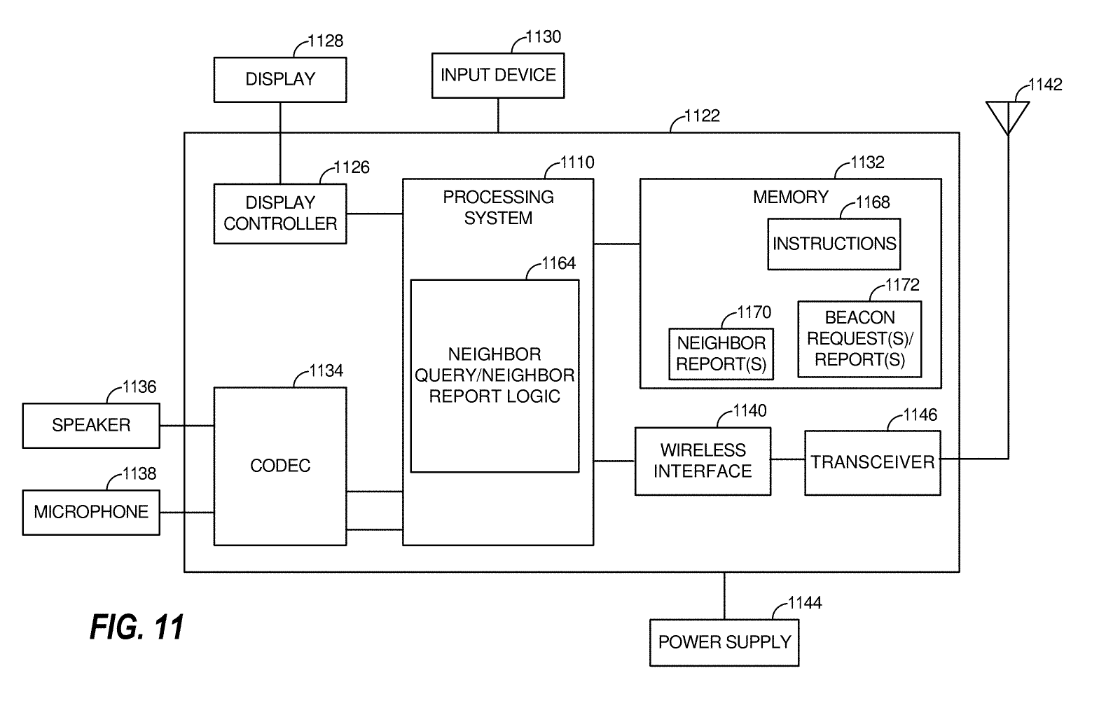

Referring to FIG. 11, a block diagram of a particular illustrative wireless communication device is depicted and generally designated 1100. The device 1100 includes a processing system 1110, such as a digital signal processor, coupled to a memory 1132. In an illustrative example, the device 1100, or components thereof, may include, or be included in, the APs, the neighboring APs, and the STAs described herein. In another illustrative example, the device 1100, or components thereof, may include, or be included in, the AP_1 102, the set of STAs 110 (including the STA_1 112, the STA_2 114, and the STA_3 116), the set of neighboring APs 120 (including the AP_2 122, the AP_3 124, and the AP_4 126), and the unassociated STA (the STA_4 132) of FIG. 1.

The processing system 1110 may be configured to execute software, such as a program implemented by computer-readable code or instructions 1168 stored in the memory 1132, which may be a non-transitory computer readable medium. Additionally, or alternatively, the processing system 1110 may be configured to implement instructions stored in a memory of a wireless interface 1140 (e.g., an IEEE 802.11 wireless interface and/or a Wi-Fi Alliance standard compliant interface). In a particular implementation, the processing system 1110 may be configured to operate in accordance with one or more of the processes described in FIGS. 6-10. For example, the processing system 1110 may include neighbor query/neighbor report logic 1164 to execute at least one of the processes described in FIGS. 6-10. The processing system 1110 may also be configured to receive, determine, store, and/or retrieve (e.g., access) a neighbor report(s) 1170 (including list(s) of neighboring APs) and/or a beacon request(s)/report(s) 1172 (including beacon report requests/beacon reports). For example, the neighbor report(s) 1170 and/or the beacon report(s) 1172 may be stored in the memory 1132. Depending on the implementation, the neighbor report(s) 1170 may include neighbor reports that includes a filtered list of neighboring APs or a customized list of neighboring APs, as illustrative, non-limiting examples. Also depending on the implementation, the beacon report(s) 1172 may include a beacon report generated by a station, such as the station STA_1 112 or a beacon report request generated by an AP, such as the AP_1 102.

The wireless interface 1140 may be coupled to the processing system 1110 and to an antenna 1142. For example, the wireless interface 1140 may be coupled to the antenna 1142 via a transceiver 1146, such that wireless data received via the antenna 1142 and may be provided to the processing system 1110. The transceiver 1146 may include a transmitter, a receiver, or a combination thereof. The transceiver 1146 may be configured to wirelessly communicate (e.g., transmit and/or receive) data, such as a neighbor report, a beacon report, a beacon report request, a neighbor query request, a beacon message, a probe request, a probe response, a probe message, a fast initial link setup (FILS) discovery frame, or a combination thereof, as illustrative, non-limiting examples. For example, the processing system 1110 may be configured to initiate a beacon report request of a format as described herein or a neighbor report with a filtered list of neighboring APs (or a customized list of neighboring APs) to be wirelessly communicated by the transceiver 1146 (e.g., transmitted using a transmitter in the transceiver 1146) to a STA, such as STA_1 112. As another example, the processing system 1110 may be configured to initiate a beacon report to be wirelessly communicated by the transceiver 1146 (e.g., transmitted using a transmitter in the transceiver 1146) to an AP, such as the AP_1 102. Various frames may also be received using the transceiver 1146 (e.g., received using a receiver in the transceiver 1146) and then provided to the processing system 1110.

A coder/decoder (CODEC) 1134 can also be coupled to the processing system 1110. A speaker 1136 and a microphone 1138 can be coupled to the CODEC 1134. A display controller 1126 can be coupled to the processing system 1110 and to a display device 1128. In a particular implementation, the processing system 1110, the display controller 1126, the memory 1132, the CODEC 1134, and the wireless interface 1140 are included in a system-in-package or system-on-chip device 1122. In some implementations, an input device 1130 and a power supply 1144 are coupled to the system-on-chip device 1122. Moreover, as illustrated in FIG. 11, the display device 1128, the input device 1130, the speaker 1136, the microphone 1138, the antenna 1142, and the power supply 1144 may be external to the system-on-chip device 1122. However, each of the display device 1128, the input device 1130, the speaker 1136, the microphone 1138, the antenna 1142, and the power supply 1144 can be coupled to at least one component of the system-on-chip device 1122, such as an interface or a controller.

The various aspects of the disclosure described above may be performed by any suitable means capable of performing the corresponding functions. The means may include various hardware and/or software component(s) and/or module(s), including, but not limited to a circuit, an application specific integrated circuit (ASIC), or processor (processing system). For example, means for transmitting (or means for outputting for transmission) may include an interface (e.g., a network interface such as the wireless interface 1140), a transmitter (e.g., a transmitter that is part of the transceiver 1146, as described) and/or an antenna(s) (e.g., the antenna 1142). Means for receiving, which includes means for obtaining when used in receiving data or information, may include an interface (e.g., a network interface such as the wireless interface 1140), a receiver (e.g., a receiver that is part of the transceiver 1146, as described) and/or an antenna(s) (e.g., the antenna 1142). Means for processing, means for obtaining, means for generating, means for selecting, means for decoding, means for comparing, means for filtering, means for customizing, or means for determining may include a processing system (e.g., the processing system 1110), which may include one or more processors, the neighbor query/neighbor response logic 1164, and/or the instructions 1168 in the memory 1132 (e.g., implementing the processes as described in FIGS. 2 and 6-10) as executed by a processor or a processing system.

In some cases, rather than actually transmitting a frame, data, information, or other element, a device may output the frame, data, information, or other element for transmission. Thus, means for outputting for transmission (or, simply, means for outputting) may include, for example, a processing system (e.g., the processing system 1110) that may output a frame, via a bus interface or another interface (e.g., the wireless interface 1140), to a radio frequency (RF) front end (e.g., transceiver 1146) that handles the transmission. Similarly, rather than actually receiving a frame, data, information, or other element, a device may have an interface to obtain the frame, data, information, or other element that is sent from another device. Thus, means for receiving may include, for example, a processing system (e.g., the processing system 1110) that may receive the frame, data, information, or other element, via a bus interface or another interface (e.g., the wireless interface 1140), from an RF front end (e.g., transceiver 1146) that performs the reception.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Moreover, “determining” may include resolving, selecting, choosing, establishing, filtering (e.g., based on one or more criteria), customizing, and the like. It should be noted that the term “determining” may also be applied to “obtaining”, such as where a result is obtained using a means for obtaining. Thus, the term “obtaining” may encompass all the variety of actions as described for the term “determining” and all other listed actions that may be substituted for “determining” in the means for determining may encompass any structure described for “means for obtaining”.

Those of skill would further appreciate that any of the various illustrative logical blocks, modules, processors (including processing systems), means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, a station, a mobile device, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In general, these may be referred to as a processing system.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor” and/or a “processing system”, both of which may be used interchangeably) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In addition, for other aspects the computer-readable medium may include transitory computer-readable medium (e.g., a signal). Combinations of the above should also be included within the scope of computer-readable media. In some aspects, a computer program product may comprise packaging materials.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. A “set” of elements may refer to any number of those elements, including zero elements. A set with zero elements may also be referred to as a null or empty set. Moreover, a “subset” of a set of elements may also refer to any number of those elements, including zero. In general, unless otherwise noted, the subset will contain a fewer number of elements (including zero elements) than the set from which those elements belong. Further, as applied to information or data, a subset of information or a subset of data may refer to no information or no data, respectively. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. An apparatus for wireless communication, comprising:
a processing system configured to generate a request for information about one or more neighboring wireless nodes; and
an interface configured to output the request for transmission and, thereafter, obtain a response to the request,
wherein the processing system is further configured to:
filter, based on the response to the request, a list of network resources; and
generate a report comprising the filtered list of network resources.

2. The apparatus of claim 1, wherein the request comprises one or more characteristics to be reported in the response for each of the one or more neighboring wireless nodes.

3. The apparatus of claim 1, wherein the response comprises a beacon report and the processing system is further configured to:
filter the list of network resources based on the beacon report.

4. The apparatus of claim 1, wherein the response comprises access point information and the processing system is further configured to:
filter the list of network resources based on the access point information.

5. The apparatus of claim 1, wherein the filtered list of the network resources comprises one or more access points and the processing system is further configured to:
customize which of the one or more access points to remain in the filtered list of network resources, wherein the report is generated to comprise the customized list of network resources.

6. The apparatus of claim 1, wherein the filtered list of network resources comprises one or more access points with which a wireless node may associate, wherein the report is generated to further comprise one or more operating parameters to enable the wireless node to determine whether to associate with the one or more access points.

7. The apparatus of claim 6, wherein the one or more operating parameters comprise at least one of a security domain, a vendor identifier, a network subnet, a communications frequency spectrum, a protocol capability, an access capability, or a capacity parameter.

8. The apparatus of claim 1, wherein the filtered list of network resources comprises one or more access points and wherein the processing system is further configured to:
remove any access point from the filtered list of network resources based on one or more filtering criteria, wherein the report is generated to comprise any remaining access points in the filtered list of network resources after the removal.

9. The apparatus of claim 8, wherein the one or more filtering criteria comprise at least one of a security domain, a vendor identifier, a network subnet, a communications frequency spectrum, a protocol capability, an access capability, or a capacity parameter.

10. A method for wireless communication, comprising:
generating a request for information about one or more neighboring wireless nodes;
outputting the request for transmission and, thereafter, obtaining a response to the request;
filtering, based on the response to the request, a list of network resources; and
generating a report comprising the filtered list of network resources.

11. The method of claim 10, wherein the request comprises one or more characteristics to be reported in the response for each of the one or more neighboring wireless nodes.

12. The method of claim 10, wherein the response comprises a beacon report and the method further comprises:
filtering the list of network resources based on the beacon report.

13. The method of claim 10, wherein the response comprises access point information and the method further comprises:
filtering the list of network resources based on the access point information.

14. The method of claim 10, wherein the filtered list of the network resources comprises one or more access points and the method further comprises:
customizing which of the one or more access points to remain in the filtered list of network resources, wherein the report is generated to comprise the customized list of network resources.

15. The method of claim 10, wherein the filtered list of network resources comprises one or more access points with which a wireless node may associate, wherein the report is generated to further comprise one or more operating parameters to enable the wireless node to determine whether to associate with the one or more access points.

16. The method of claim 15, wherein the one or more operating parameters comprise at least one of a security domain, a vendor identifier, a network subnet, a communications frequency spectrum, a protocol capability, an access capability, or a capacity parameter.

17. The method of claim 10, wherein the filtered list of network resources comprises one or more access points and wherein the method further comprises:
removing any access point from the filtered list of network resources based on one or more filtering criteria, wherein the report is generated to comprise any remaining access points in the filtered list of network resources after the removal.

18. The method of claim 17, wherein the one or more filtering criteria comprise at least one of a security domain, a vendor identifier, a network subnet, a communications frequency spectrum, a protocol capability, an access capability, or a capacity parameter.

19. An access point, comprising:
a processing system configured to generate a request for information about one or more neighboring wireless nodes;
a transmitter configured to transmit the request; and
a receiver configured to receive a response to the request;
wherein the processing system is further configured to:
filter, based on the response to the request, a list of network resources; and
generate a report comprising the filtered list of network resources.

20-29. (canceled)
